(19) United States
(12) Patent Application Publication
(10) Pub. No.: US 2022/0163700 A1
(43) Pub. Date: May 26, 2022

(54) LENS ASSEMBLY AND FABRICATING METHOD THEREOF, AND DISPLAYING DEVICE

(71) Applicant: BOE Technology Group Co., Ltd., Beijing (CN)

(72) Inventors: Feng ZHANG, Beijing (CN); Kang GUO, Beijing (CN); Meili WANG, Beijing (CN); Renquan GU, Beijing (CN); Dongfei HOU, Beijing (CN); Libo WANG, Beijing (CN); Guangcai YUAN, Beijing (CN); Xue DONG, Beijing (CN); Wei WANG, Beijing (CN); Detian MENG, Beijing (CN); Jing YU, Beijing (CN); Jing LIU, Beijing (CN)

(21) Appl. No.: 17/490,913

(22) Filed: Sep. 30, 2021

(30) Foreign Application Priority Data
Nov. 24, 2020 (CN) 202011335662.6

(51) Int. Cl. G02B 3/00

(52) U.S. Cl. CPC G02B 3/0056; G02B 3/005; G02B 3/0031

(57) ABSTRACT

The present disclosure provides a lens assembly and a fabricating method thereof, and a displaying device, and relates to the technical field of optics. The lens assembly includes a plurality of lenses that are not connected to each other and a plurality of isolating parts, the isolating parts are provided between neighboring instances of the lenses, and a refractive index of the isolating parts is different from a refractive index of the lenses.

The application claims priority to Chinese Patent Application No. 202011335662.6, titled “LENS ASSEMBLY AND FABRICATING METHOD THEREOF, AND DISPLAYING DEVICE” and filed to the State Patent Intellectual Property Office on Nov. 24, 2020, the contents of which are incorporated herein by reference in its entirety.

### TECHNICAL FIELD

The present disclosure relates to the technical field of optics, and particularly relates to a lens assembly and a fabricating method thereof, and a displaying device.

### BACKGROUND

Microlens arrays comprise a plurality of connected or discrete microlenses, and may be fabricated on relative devices (such as displays and sensors) or transparent base plates. They have the function of refracting light rays and focusing light rays, and may be applied to various devices, such as naked-eye 3D displaying devices.

Currently, microlens arrays are usually fabricated by using imprinting method or thermal reflux method. Because the thermal reflux method has the advantages such as a simple process, and that the aligning of lithography grade with the device can be realized, it is applied more extensively.

### SUMMARY

The embodiments of the present disclosure provide a lens assembly and a fabricating method thereof, and a displaying device.

The embodiments of the present disclosure employ the following technical solutions:

in an aspect, there is provided a lens assembly, wherein the lens assembly comprises a plurality of lenses not connected to each other and a plurality of isolating parts, the isolating parts are provided between neighboring instances of the lenses, and a refractive index of the isolating parts is different from a refractive index of the lenses.

Optionally, the plurality of lenses are arranged side by side, and are arranged in stagger with the plurality of isolating parts.

Optionally, all of the isolating parts and the lenses are strip-shaped, and the isolating parts and the lenses are parallel.

Optionally, the plurality of lenses are arranged in an array, and the isolating parts are arranged between two neighboring rows of the lenses.

Optionally, the isolating parts are provided between every two neighboring rows of the lenses.

Optionally, the plurality of lenses are arranged in an array, and the plurality of isolating parts are distributed in a net-like form.

Optionally, a maximum height of the isolating parts is less than a maximum height of the lenses.

Optionally, the maximum height of the isolating parts is less than 5% of the maximum height of the lenses.

Optionally, a material of the isolating parts comprises any one of a light-penetration inorganic material, a light-penetration organic material and a non-light-penetration light absorbing material.

Optionally, the lens assembly further comprises a light regulating layer;

the light regulating layer is located on the light exiting side of the plurality of lenses, covers the plurality of lenses and the plurality of isolating parts, and the refractive index of the light regulating layer is different from the refractive index of the lenses.

Optionally, the lenses are lenticular lenses or hemispherical lenses.

Optionally, the lenses are micro lenses.

In another aspect, there is provided a displaying device, wherein the displaying device comprises a display panel and the lens assembly stated above, and the lens assembly is provided on a light exiting side of the display panel.

In yet another aspect, there is provided another displaying device, wherein the displaying device comprises a display panel and a lens unit, the lens unit is provided on a light exiting side of the display panel, and the lens unit is obtained by removing the isolating parts of the lens assembly stated above.

In still another aspect, there is provided a fabricating method of the lens assembly stated above, wherein the method comprises:

forming a lens layer and the plurality of isolating parts, wherein the lens layer is provided with a plurality of gaps, and the isolating parts are located in the gaps; and

performing thermal reflux to the lens layer and the plurality of isolating parts, to form the plurality of lenses not connected to each other.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present application are provided below.

### BRIEF DESCRIPTION OF THE DRAWINGS

In order to more clearly illustrate the technical solutions of the embodiments of the present disclosure or the related art, the figures that are required to describe the embodiments or the related art will be briefly introduced below. Apparently, the figures that are described below are merely embodiments of the present disclosure, and a person skilled in the art can obtain other figures according to these figures without paying creative work.

FIG. 1 is a schematic structural diagram of lens adhesion according to an embodiment of the present disclosure;

FIG. 2 is a schematic diagram of the microlens spacing according to an embodiment of the present disclosure;

FIG. 3 is a schematic structural diagram of the microlens array according to an embodiment of the present disclosure;

FIG. 4 is a schematic flow chart of the fabrication of the microlens array shown in FIG. 3;

FIG. 5 is a schematic structural diagram of the lens assembly according to an embodiment of the present disclosure;

FIG. 6 is a schematic structural diagram of the lens unit according to an embodiment of the present disclosure;

FIG. 7 is a top view of the lens assembly according to an embodiment of the present disclosure;

FIG. 8 is a top view of the lens assembly according to another embodiment of the present disclosure;

FIG. 9 is a top view of the lens assembly according to yet another embodiment of the present disclosure;

FIG. 10 is a top view of the lens assembly according to still another embodiment of the present disclosure;

FIG. 11 is a schematic flow chart of the fabrication of the lens assembly according to an embodiment of the present disclosure;

FIG. 12 is a schematic flow chart of the fabrication of the lens assembly according to another embodiment of the present disclosure;

FIG. 13 is a schematic flow chart of the fabrication of the lens unit according to an embodiment of the present disclosure;

FIG. 14 is a schematic flow chart of the fabrication of the lens unit according to another embodiment of the present disclosure; and

FIG. 15 is a schematic flow chart of fabricating method of the lens assembly according to another embodiment of the present disclosure.

### DETAILED DESCRIPTION

The technical solutions of the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

In the embodiments of the present disclosure, the meaning of “plurality of” is “two or more”, unless explicitly and particularly defined otherwise.

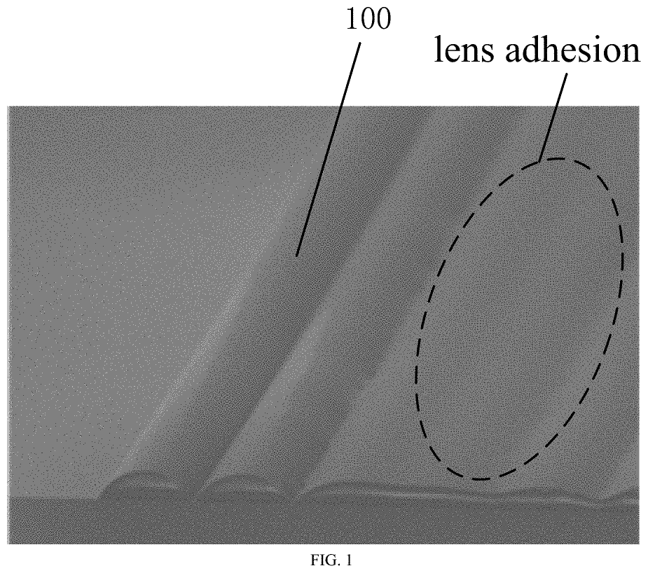

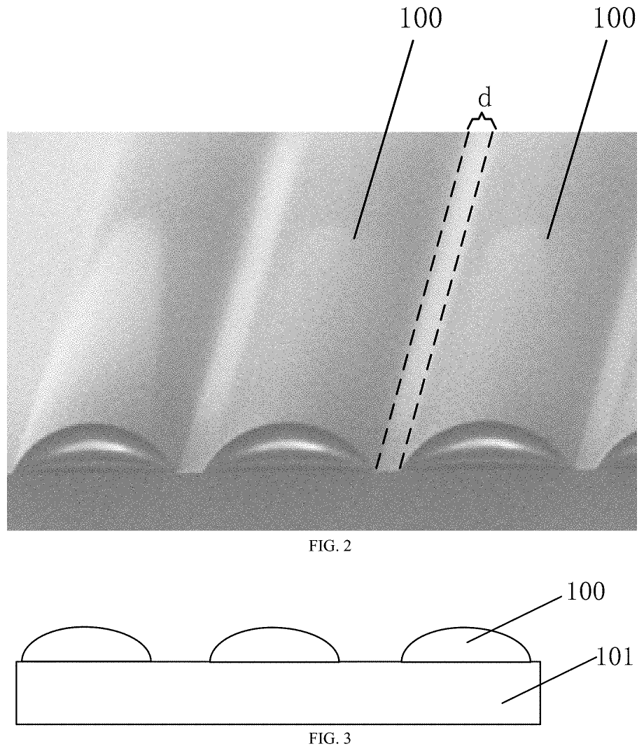

In the thermal reflux method, the cement material is melted by heating to form the shape of the microlenses. During the process of heating, melting and flowing, if the distances between the neighboring microlenses are too small, the problem that the microlenses 100 have adhesion, as shown in FIG. 1, easily happens, which results in that the appearance of the microlenses changes, and the microlenses cannot serve to refract or focus light rays. Referring to FIG. 2, if the distance d between the neighboring microlenses 100 is too large, the luminous efficiency is reduced, which affects the function of the device. For example, naked-eye 3D displaying devices might have the problem of 3D interference, or problems such as that the microlens arrays cannot increase the luminous efficiency.

Therefore, in the fabrication of the microlens arrays by using the thermal reflux method, it is a problem required to be solved urgently how to address the lens adhesion caused by a too small distance between the microlenses, to reduce the distances between the microlenses to the largest extent.

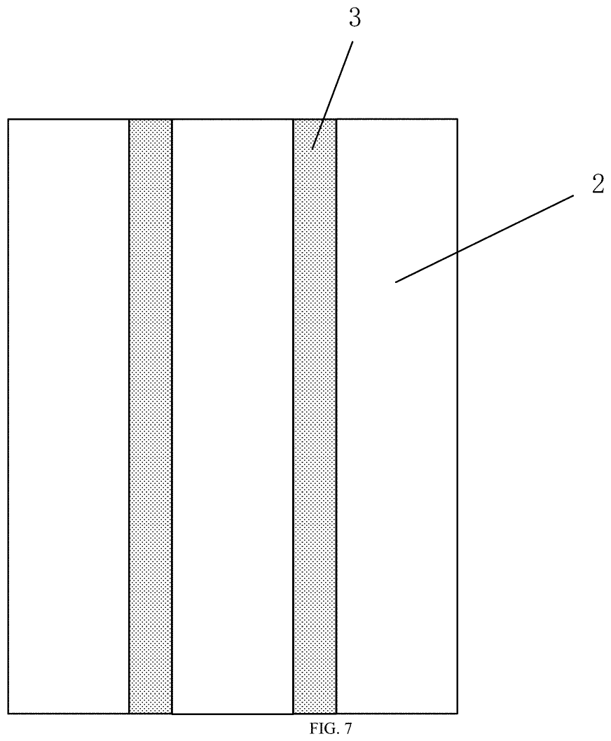

An embodiment of the present disclosure provides a lens assembly. Referring to FIG. 5, the lens assembly comprises a plurality of lenses 2 that are not connected to each other and a plurality of isolating parts 3, the isolating parts 3 are provided between neighboring lenses 2, and the refractive index of the isolating parts is different from the refractive index of the lenses.

The particular quantity and shapes of the isolating parts are not limited herein.

It should be noted that, among the plurality of lenses that are not connected to each other, the isolating parts are provided between every neighboring lenses, or, the isolating parts are provided between some of neighboring lenses. In order to prevent the problem of lens adhesion to the largest extent, the former is preferable.

The shapes and the arrangement mode of the lenses are not limited herein. As an example, the lenses may be lenticular lenses or hemispherical lenses. The plurality of lenses may be arranged side by side or arranged in an array.

The lenses may be microlenses, and their sizes may be of micrometer scale.

That the refractive index of the isolating parts is different from the refractive index of the lenses refers to that the refractive index of the isolating parts may be greater than the refractive index of the lenses, or, the refractive index of the isolating parts may be less than the refractive index of the lenses, which may be particularly determined according to practical demands.

In addition, in order to further improve the effect of light regulation, the lens assembly may further comprise a light regulating layer, and the light regulating layer may be located on the light exiting side of the plurality of lenses, and cover the plurality of lenses and the plurality of isolating parts. The refractive index of the light regulating layer is different from the refractive index of the lenses. In other words, the refractive index of the light regulating layer may be greater than or less than the refractive index of the lenses. The refractive index of the isolating parts and the refractive index of the light regulating layer may be equal, and may also be different, and, in order to facilitate the light regulation, the former is preferable.

The lens assembly has the function of refracting light rays and focusing light rays, and may be applied to devices requiring light regulation such as a displaying device, a sensor and an optical functional thin film. As an example, by applying the lens assembly to the surface of a display panel, a naked-eye 3D effect can be realized. By applying the lens assembly to micro-displaying devices such as AR (Augmented Reality) and VR (Virtual Reality), the optical extraction efficiency can be increased. By applying the lens assembly to an optical functional thin film, the effect of photodiffusion can be improved.

The embodiments of the present disclosure provide a lens assembly and a fabricating method thereof, and a displaying device, wherein the lens assembly comprises a plurality of lenses that are not connected to each other and a plurality of isolating parts, the isolating parts are provided between neighboring instances of the lenses, and a refractive index of the isolating parts is different from a refractive index of the lenses. Accordingly, in the fabrication of the lens assembly, the plurality of isolating parts may be fabricated firstly, and, subsequently, the plurality of lenses may be formed by using a thermal reflux method. Accordingly, during the thermal reflux process, the isolating parts can isolate the materials in the molten state of the neighboring lenses, thereby preventing the problem of lens adhesion, to reduce the distances between the microlenses to the largest extent, to in turn increase the optical extraction efficiency, and improve the optical effect.

A particular structure of the plurality of lenses and the plurality of isolating parts will be provided below.

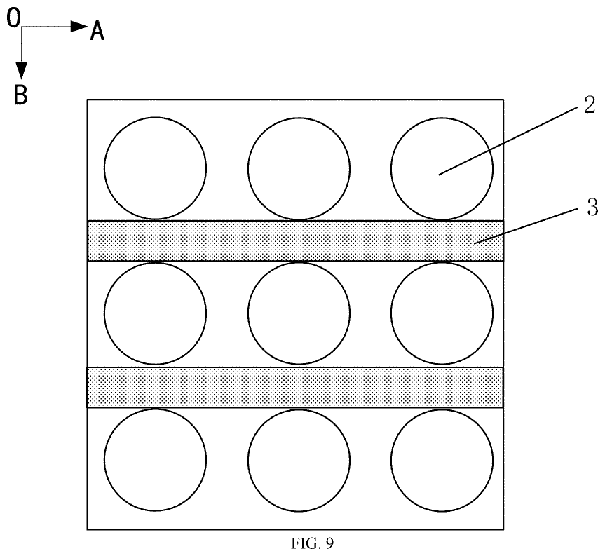

Optionally, referring to FIG. 7, the plurality of lenses 2 are arranged side by side, and are arranged in stagger with the plurality of isolating parts 3.

The direction of the side-by-side arrangement of the plurality of lenses is not limited. As an example, if the lens assembly is applied to a display panel, the plurality of lenses may be arranged side by side in the direction along the longer sides of the display panel, or, the plurality of lenses may also be arranged side by side in the direction along the shorter sides of the display panel, which may be particularly selected according to design demands. FIG. 7 illustrates by taking the case as an example in which three lenses 2 and two isolating parts 3 are arranged in stagger.

Further optionally, referring to FIG. 7, all of the isolating parts 3 and the lenses 2 are strip-shaped, and the isolating parts 3 and the lenses 2 are parallel. That can further reduce the distances between the neighboring lenses, thereby further increasing the optical extraction efficiency, and improving the optical effect.

It should be noted that, if the lens assembly is arranged on a display panel, then the shape of the cross section of the isolating parts in the direction perpendicular to the display panel may be any one of a triangle, a square, a rectangle and a trapezoid, and the shape of the cross section of the lenses in the direction perpendicular to the display panel may be any one of a semicircle, a square, a rectangle and a trapezoid.

Another particular structure of the plurality of lenses and the plurality of isolating parts will be provided below.

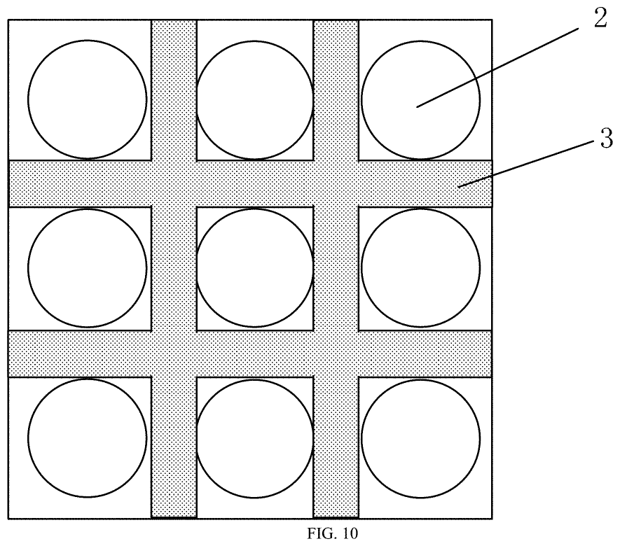

Optionally, as shown in FIGS. 8 and 9, the plurality of lenses 2 are arranged in an array, and the isolating parts 3 are arranged between two neighboring rows of the lenses.

That the isolating parts are arranged between two neighboring rows of the lenses refers to that the isolating parts may, as shown in FIG. 8, be arranged between two rows (i.e., the two columns shown in FIG. 8) of the lenses that are arranged in the direction OA; or, the isolating parts may also, as shown in FIG. 9, be arranged between two rows (i.e., the two rows shown in FIG. 9) of the lenses that are arranged in the direction OB; or, the isolating parts may also be arranged between two neighboring rows of the lenses that are arranged in another direction, which is not limited herein. Both of FIGS. 8 and 9 illustrate by taking the case as an example in which 9 lenses are arranged in an array of 3*3.

The shapes of the isolating parts are not limited herein. As an example, the isolating parts may be strip-shaped. If the lens assembly is arranged on a display panel, then the shape of the cross section of the isolating parts in the direction perpendicular to the display panel may be a triangle, a square, a rectangle, a trapezoid and so on, and the shapes of the orthographic projections of the lenses on the display panel may be any one of a circle, an ellipse and a polygon, wherein the polygon includes a square, a rectangle, a trapezoid, a pentagon and so on.

In order to prevent the problem of lens adhesion to the largest extent, and further reduce the distances between the lenses, to further increase the degree of close arrangement of the lenses, the isolating parts are provided between every two neighboring rows of the lenses.

Yet another particular structure of the plurality of lenses and the plurality of isolating parts will be provided below.

Optionally, referring to FIG. 10, the plurality of lenses 2 are arranged in an array, and the plurality of isolating parts 3 are distributed in a net-like form. In this case, the isolating parts are provided between every two neighboring lenses 2. Such a structure can prevent the problem of lens adhesion to the largest extent.

If the lens assembly is arranged on a display panel, then the shape of the cross section of the isolating parts in the direction perpendicular to the display panel may be a triangle, a square, a rectangle, a trapezoid and so on, and the shapes of the orthographic projections of the lenses on the display panel may be any one of a circle, an ellipse and a polygon, wherein the polygon includes a square, a rectangle, a trapezoid, a pentagon and so on.

In order to prevent influencing the configuration of the optical path to the largest extent, the maximum height of the isolating parts is less than the maximum height of the lenses.

It should be noted that the maximum height of an isolating part refers to the distance between the bottom and the top of the isolating part, and the maximum height of a lens refers to the distance between the bottom and the top of the lens. As an example, referring to FIG. 5, the lens assembly is provided on a front film layer 1, and the shape of the cross section of the isolating parts 3 in the direction perpendicular to the front film layer 1 is a rectangle; accordingly, the maximum height of the isolating parts is h1 shown in FIG. 5. The surface of the one side of the lenses 2 that is further away from the front film layer 1 is an arcuate face, and accordingly, the maximum height of the lenses is h2 shown in FIG. 5. The front film layer is not limited herein, and it may be a substrate, or another film layer that requires to be provided with the lens assembly.

Optionally, the maximum height of the isolating parts is less than 5% of the maximum height of the lenses, to further reduce the influence on the optical path, and at the same time ensure the effect of isolation.

Optionally, a material of the isolating parts comprises any one of a light-penetration inorganic material, a light-penetration organic material and a non-light-penetration light absorbing material.

The light-penetration inorganic material may include silicon oxide or silicon nitride. The light-penetration organic material may include a light-penetration organic cement material. The non-light-penetration light absorbing material may include ferrous-metal oxides, such as molybdenum oxide and cupric oxide, or, may also include ferrous-metal alloys. The isolating parts fabricated by using the non-light-penetration light absorbing material can absorb parasitic light, and by applying the lens assembly to a naked-eye 3D displaying device, interference between the light rays of the different lenses can be prevented, thereby improving the effect of 3D displaying.

An embodiment of the present disclosure further provides a displaying device, wherein the displaying device comprises a display panel and the lens assembly stated above, and the lens assembly is provided on a light exiting side of the display panel.

The display panel may be any one of an OLED (Organic Light Emitting Diode) display panel, a Micro LED micro-display panel and a Mini LED micro-display panel. Alternatively, the display panel may also be an LCD (Liquid Crystal Display) display panel. The OLED display panel may be a WOLED (White-Light Organic Light Emitting Diode) display panel, wherein the pixels of the WOLED display panel emit white light, and an additionally provided color light filter layer is required to realize color displaying. Alternatively, the OLED display panel may also be an RGB OLED (Red-Green-Blue Organic Light Emitting Diode) display panel, wherein the pixels of the RGB OLED display panel can directly emit lights of different colors, and it is not required to provide a color light filter layer.

The displaying device may be any one of a naked-eye 3D displaying device, an AR displaying device and a VR displaying device, or a product or component that comprises the display panel and the lens assembly, such as a television set, a digital camera, a mobile phone and a tablet personal computer. The displaying device has a good effect of displaying, and a good user experience.

An embodiment of the present disclosure further provides a displaying device, wherein the displaying device comprises a display panel and a lens unit, the lens unit is provided on a light exiting side of the display panel, and the lens unit is obtained by removing the isolating parts of the lens assembly stated above.

It should be noted that, in order to prevent the influence on the optical path by the isolating parts, the isolating parts of the lens assembly may be removed, to form a lens unit. In order to further improve the effect of light regulation, the lens unit may further comprise a light regulating layer, and the light regulating layer may be located on the light exiting side of the plurality of lenses, and cover the plurality of lenses. The refractive index of the light regulating layer is different from the refractive index of the lenses. In other words, the refractive index of the light regulating layer may be greater than or less than the refractive index of the lenses. Preferably, the refractive index of the light regulating layer is less than the refractive index of the lenses. As an example, the light regulating layer may be formed by using a high-refractive-index cement material, wherein the refractive index of the high-refractive-index cement material may be greater than 1.5. The lenses may be formed by using a low-refractive-index cement material, wherein the refractive index of the low-refractive-index cement material may be approximately 1.4.

The display panel may be any one of an OLED (Organic Light Emitting Diode) display panel, a Micro LED micro-display panel and a Mini LED micro-display panel. Alternatively, the display panel may also be an LCD (Liquid Crystal Display) display panel. The OLED display panel may be a WOLED (White-Light Organic Light Emitting Diode) display panel, wherein the pixels of the WOLED display panel emit white light, and an additionally provided color light filter layer is required to realize color displaying. Alternatively, the OLED display panel may also be an RGB OLED (Red-Green-Blue Organic Light Emitting Diode) display panel, wherein the pixels of the RGB OLED display panel can directly emit lights of different colors, and it is not required to provide a color light filter layer.

The displaying device may be any one of a naked-eye 3D displaying device, an AR displaying device and a VR displaying device, or a product or component that comprises the display panel and the lens assembly, such as a television set, a digital camera, a mobile phone and a tablet personal computer. The displaying device has a good effect of displaying, and a good user experience.

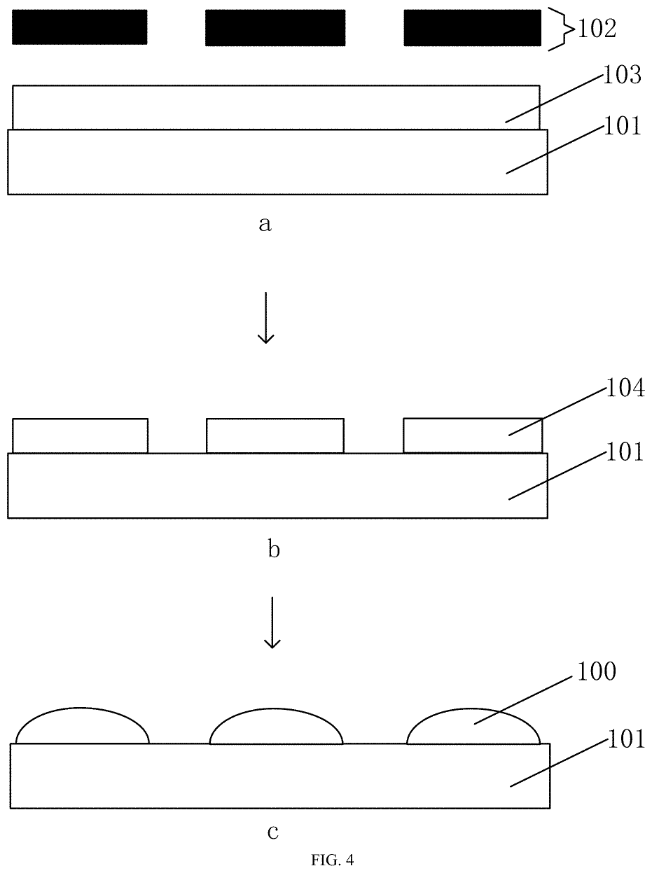

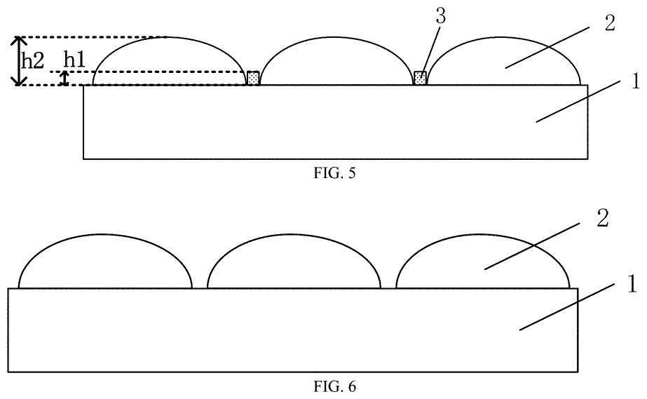

In the related art, the microlens array shown in FIG. 3 is formed by using a photolithographic thermal reflux method. In FIG. 3, microlenses 100 are provided on a substrate 101. Referring to FIG. 4, the fabricating method of the microlens array comprises the following steps:

S100: referring to a of FIG. 4, exposing a microlens thin film 103 by using a mask 102.

S101: developing the microlens thin film obtained after the exposure in S100, to obtain a microlens layer 104 that has been patterned shown in b of FIG. 4.

S102: performing thermal reflux to the microlens layer that has been patterned in S101, to form the microlens array shown in c of FIG. 4, wherein the surfaces of the sides of the microlenses 100 that are further away from the substrate 10 are curved surfaces.

In the above fabricating method, if the distances between the neighboring microlenses are too small, the problem of microlens adhesion easily happens, which results in that the appearance of the microlenses changes, the microlenses cannot serve to refract or focus light rays, and the performance of the microlens array is highly deteriorated.

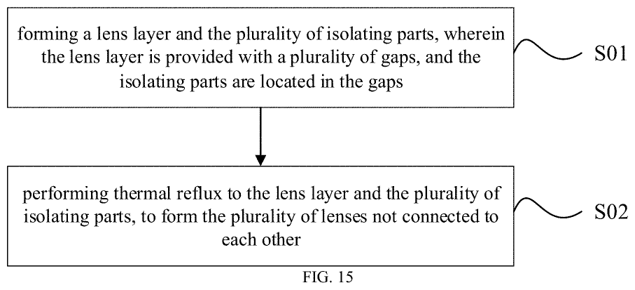

In view of that, referring to FIG. 15, an embodiment of the present disclosure further provides a fabricating method of the lens assembly stated above, wherein the method comprises:

S01: forming a lens layer and the plurality of isolating parts, wherein the lens layer is provided with a plurality of gaps, and the isolating parts are located in the gaps.

S02: performing thermal reflux to the lens layer and the plurality of isolating parts, to form the plurality of lenses that are not connected to each other, wherein a refractive index of the isolating parts is different from a refractive index of the lenses.

In the above fabricating method, the lens layer and the plurality of isolating parts are firstly formed, and, subsequently, the plurality of lenses are formed by using the thermal reflux process. Accordingly, during the thermal reflux process, the isolating parts can isolate the materials in the molten state of the neighboring lenses, thereby preventing the problem of lens adhesion, to reduce the distances between the microlenses to the largest extent, to in turn increase the optical extraction efficiency, and improve the optical effect. The fabricating method is simple and easy to implement.

The sequence of the formation of the lens layer and the isolating parts in S01 is not limited herein. The sequence may be firstly forming the lens layer and then forming the isolating parts, or may also be firstly forming the isolating parts and then forming the lens layer.

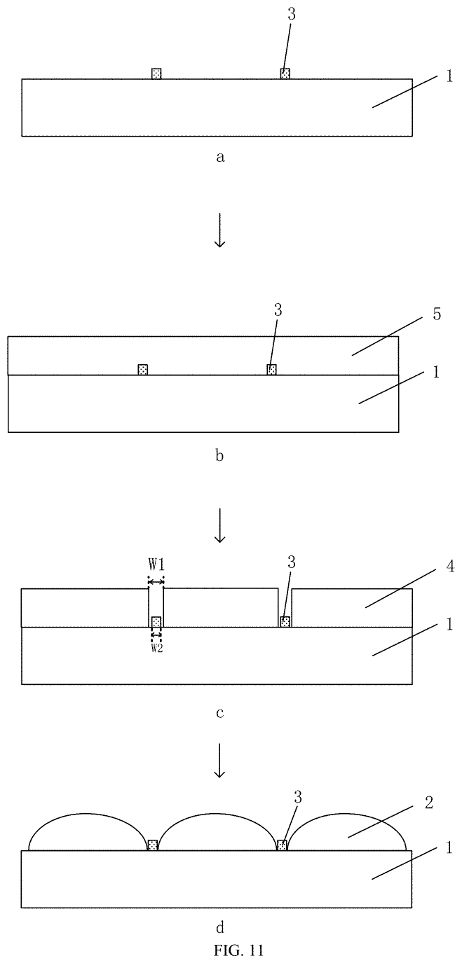

A particular fabricating method of the lens assembly will be described below. Referring to FIG. 11, the method comprises:

S11: referring to a of FIG. 11, fabricating a plurality of isolating parts 3 at predetermined positions of a front film layer 1. The front film layer may be a transparent substrate, or a device surface (for example, the surface of a display panel). The materials of the isolating parts may be any one of silicon oxide, a ferrous-metal oxide and a transparent organic layer.

S12: spread-coating an organic cement material, wherein, referring to b of FIG. 11, the organic cement material 5 covers the plurality of isolating parts 3. The refractive index of the isolating parts is different from the refractive index of the organic cement material.

S13: performing exposure and development to the organic cement material, to form a plurality of organic-cement-material units 4 shown in c of FIG. 11, and simultaneously reveal the isolating parts 3.

It should be noted that, because, in the subsequent thermal reflux process, the organic cement material, after becoming the molten state, has a certain fluidity, in order to prevent adhesion happening subsequently, referring to c of FIG. 11, the width W1 between neighboring organic-cement-material units 4 is greater than the width W2 of the isolating parts 3.

S14: performing thermal reflux to the structure in S13, to form the lenses 2 shown in d of FIG. 11.

It should be noted that the organic cement material in the molten state flows due to the surface tension, and the distances between the lenses reduce. However, because of the blocking layer, the neighboring lenses do not have adhesion therebetween.

Another particular fabricating method of the lens assembly will be described below.

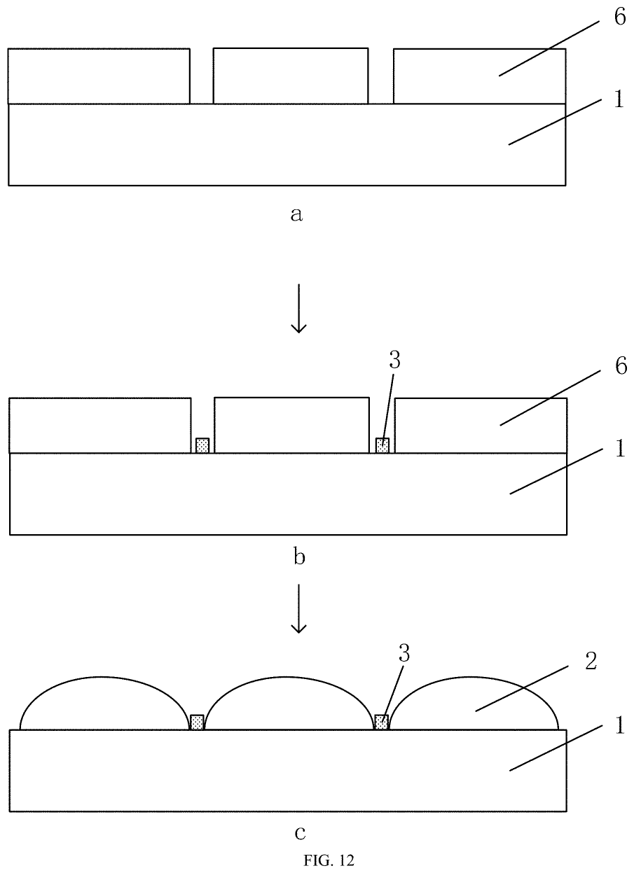

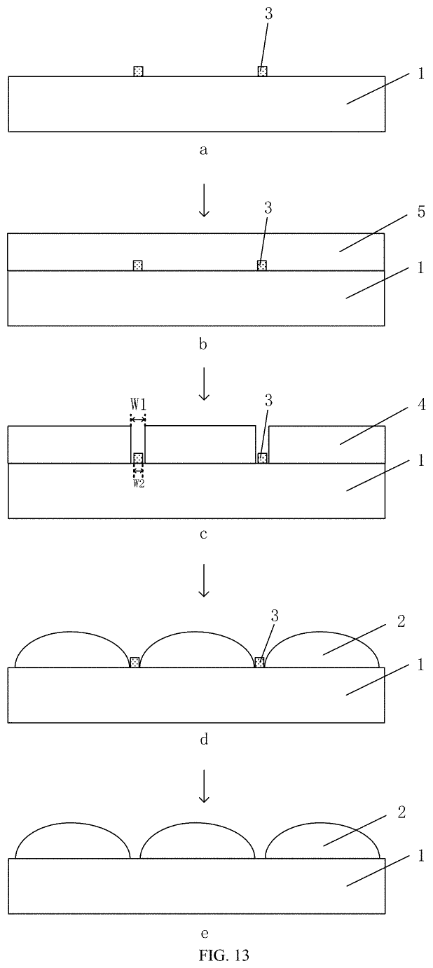

Referring to FIG. 12, the method comprises:

S21: referring to a of FIG. 12, fabricating an organic-cement-material layer 6 that has been patterned at predetermined positions of a front film layer 1, wherein the organic-cement-material layer 6 that has been patterned comprises a plurality of gaps. The front film layer may be a transparent substrate, or a device surface (for example, the surface of a display panel).

S22: forming isolating parts 3 shown in b of FIG. 12 in the gaps.

As an example, the isolating parts may be formed by vapor deposition, sputtering, spin coating and so on. The materials of the isolating parts may be any one of silicon oxide, a ferrous-metal oxide and a transparent organic layer. The refractive index of the isolating parts is different from the refractive index of the organic-cement-material layer.

S23: performing thermal reflux to the structure in S22, to form the lenses 2 shown in c of FIG. 12.

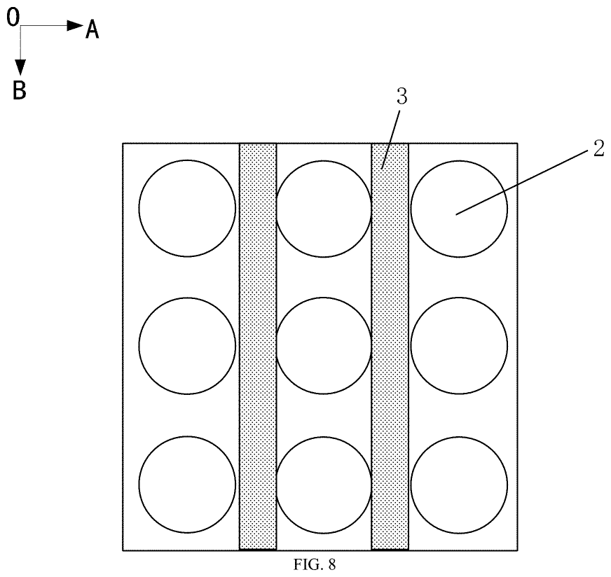

In order to prevent the influence on the optical path by the isolating parts, the isolating parts 3 of the lens assembly shown in FIG. 5 may be removed, to form the lens unit shown in FIG. 6.

A particular fabricating method of the lens unit will be described below.

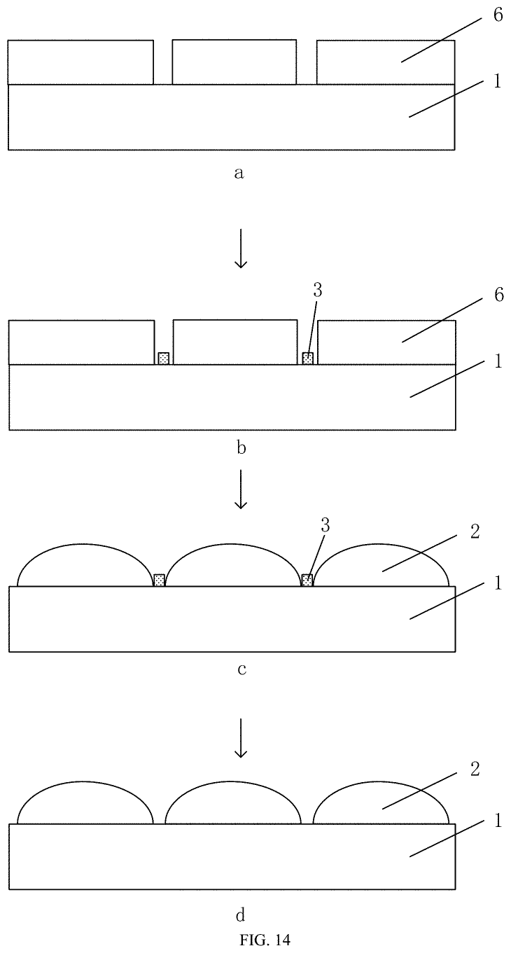

Referring to FIG. 13, the method comprises:

S31: referring to a of FIG. 13, fabricating a plurality of isolating parts 3 at predetermined positions of a front film layer 1. The front film layer may be a transparent substrate, or a device surface (for example, the surface of a display panel). The materials of the isolating parts may be any one of silicon oxide, a ferrous-metal oxide and a transparent organic layer.

S32: spread-coating an organic cement material, wherein, referring to b of FIG. 13, the organic cement material 5 covers the plurality of isolating parts 3. The refractive index of the isolating parts is different from the refractive index of the organic cement material.

S33: performing exposure and development to the organic cement material, to form a plurality of organic-cement-material units 4 shown in c of FIG. 13, and simultaneously reveal the isolating parts 3.

It should be noted that, because, in the subsequent thermal reflux process, the organic cement material, after becoming the molten state, has a certain fluidity, in order to prevent adhesion happening subsequently, the width W1 between neighboring organic-cement-material units 4 is greater than the width W2 of the isolating parts 3.

S34: performing thermal reflux to the structure in S33, to form the lenses 2 shown in d of FIG. 13.

It should be noted that the organic cement material in the molten state flows due to the surface tension, and the distances between the lenses reduce. However, because of the blocking layer, the neighboring lenses do not have adhesion therebetween.

S35: removing the plurality of isolating parts, to form the lens unit shown in e of FIG. 13.

As an example, the isolating parts may by etched by dry etching or wet etching, which may be particularly selected according to the material of the isolating parts. If the material of the isolating parts comprises silicon oxide or a transparent organic layer, dry etching may be employed. If the material of the isolating parts comprises a ferrous-metal oxide, wet etching may be employed.

Another particular fabricating method of the lens unit will be described below.

Referring to FIG. 14, the method comprises:

S41: referring to a of FIG. 14, fabricating an organic-cement-material layer 6 that has been patterned at predetermined positions of a front film layer 1, wherein the organic-cement-material layer 6 that has been patterned comprises a plurality of gaps. The front film layer may be a transparent substrate, or a device surface (for example, the surface of a display panel).

S42: forming isolating parts 3 shown in b of FIG. 14 in the gaps.

As an example, the isolating parts may be formed by vapor deposition, sputtering, spin coating and so on. The materials of the isolating parts may be any one of silicon oxide, a ferrous-metal oxide and a transparent organic layer. The refractive index of the isolating parts is different from the refractive index of the organic-cement-material layer.

S43: performing thermal reflux to the structure in S42, to form the lenses 2 shown in c of FIG. 14.

S44: removing the plurality of isolating parts, to form the lens unit shown in d of FIG. 14.

As an example, the isolating parts may by etched by dry etching or wet etching, which may be particularly selected according to the material of the isolating parts. If the material of the isolating parts comprises silicon oxide or a transparent organic layer, dry etching may be employed. If the material of the isolating parts comprises a ferrous-metal oxide, wet etching may be employed.

The above are merely particular embodiments of the present disclosure, and the protection scope of the present disclosure is not limited thereto. All of the variations or substitutions that a person skilled in the art can easily envisage within the technical scope disclosed by the present disclosure should fall within the protection scope of the present disclosure. Therefore, the protection scope of the present disclosure should be subject to the protection scope of the claims.

1. A lens assembly, wherein the lens assembly comprises a plurality of lenses not connected to each other and a plurality of isolating parts, the isolating parts are provided between neighboring instances of the lenses, and a refractive index of the isolating parts is different from a refractive index of the lenses.

2. The lens assembly according to claim 1, wherein the plurality of lenses are arranged side by side, and are arranged in stagger with the plurality of isolating parts.

3. The lens assembly according to claim 2, wherein all of the isolating parts and the lenses are strip-shaped, and the isolating parts and the lenses are parallel.

4. The lens assembly according to claim 1, wherein the plurality of lenses are arranged in an array, and the isolating parts are arranged between two neighboring rows of the lenses.

5. The lens assembly according to claim 4, wherein the isolating parts are provided between every two neighboring rows of the lenses.

6. The lens assembly according to claim 1, wherein the plurality of lenses are arranged in an array, and the plurality of isolating parts are distributed in a net-like form.

7. The lens assembly according to claim 1, wherein a maximum height of the isolating parts is less than a maximum height of the lenses.

8. The lens assembly according to claim 7, wherein the maximum height of the isolating parts is less than 5% of the maximum height of the lenses.

9. The lens assembly according to claim 1, wherein a material of the isolating parts comprises any one of a light-penetration inorganic material, a light-penetration organic material and a non-light-penetration light absorbing material.

10. The lens assembly according to claim 1, wherein the lens assembly further comprises a light regulating layer;
the light regulating layer is located on the light exiting side of the plurality of lenses, covers the plurality of lenses and the plurality of isolating parts, and the refractive index of the light regulating layer is different from the refractive index of the lenses.

11. The lens assembly according to claim 1, wherein the lenses are lenticular lenses or hemispherical lenses.

12. The lens assembly according to claim 1, wherein the lenses are micro lenses.

13. A displaying device, wherein the displaying device comprises a display panel and the lens assembly according to claim 1, and the lens assembly is provided on a light exiting side of the display panel.

14. A displaying device, wherein the displaying device comprises a display panel and a lens unit, the lens unit is provided on a light exiting side of the display panel, and the lens unit is obtained by removing the isolating parts of the lens assembly according to claim 1.

15. A fabricating method of the lens assembly according to claim 1, wherein the method comprises:
forming a lens layer and the plurality of isolating parts, wherein the lens layer is provided with a plurality of gaps, and the isolating parts are located in the gaps; and
performing thermal reflux to the lens layer and the plurality of isolating parts, to form the plurality of lenses not connected to each other.
